(19) United States
(12) Patent Application Publication
(10) Pub. No.: US 2013/0215029 A1
(43) Pub. Date: Aug. 22, 2013

(54) Tactile Guides for Touchscreens

(71) Applicant: Hugh Thomson Comer, JR., Erie, CO (US)

(72) Inventor: Hugh Thomson Comer, JR., Erie, CO (US)

(21) Appl. No.: 13/769,142

(22) Filed: Feb. 15, 2013

Related U.S. Application Data
(60) Provisional application No. 61/599,918, filed on Feb. 16, 2012.

(51) Int. Cl. G06F 3/01

(52) U.S. Cl. CPC G06F 3/016
USPC 345/161; 345/173

(57) ABSTRACT

Provided are tactile guides which may be reversibly adhered to the screen of a touchscreen device, allowing the user to know the position of displayed controls. In some embodiments, directional information is also provided by the tactile guide such that a user may detect by sense of touch up-down and/or lateral orientation of displayed controls such as slider bars or joysticks. This allows the user to quickly engage displayed controls without looking at their fingertip. The tactile guides of the invention may advantageously be configured for any software application. The tactile guides of the invention take myriad forms, including static cling films, buttons, and combinations thereof.

### CROSS-REFERENCE TO RELATED APPLICATIONS

This application is based on and claims the benefit of priority of U.S. Provisional Patent Application Ser. No. 61/599,918 filed on Feb. 16, 2012, the contents of which are incorporated by reference.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

In recent years, there has been a huge proliferation of consumer devices which employ capacitive or resistive touchscreens. An enormous number of applications have been developed for smartphones, tablets, and other devices that employ touchscreens. Touchscreen technology allows users to interact with software and hardware via finger taps, touches, or movements. Common interactive situations include gaming, keyboard typing, etc.

A significant drawback of touchscreen technology is that the smooth surface of the touchscreen, typically glass, does not provide any tactile positional feedback to the user. In other words, the user is forced to look at the screen to see where his or her fingers are in order to guide them to the desired displayed button or other interface. This extraneous action generally slows the speed of user input.

In certain contexts, especially gaming, one solution for the aforementioned problem is the use of a physical joystick which can be attached to the screen over a displayed joystick control region and which can be manipulated by the user. The user's manipulation of the physical joystick is translated into conductive contacts which drive the on-screen displayed joystick control. Exemplary physical joystick interfaces include the Joystick-It iPad Arcade Stick™ (ThinkGeek), a similar miniature joystick product from Neewer, Inc, the Fling™ Game Controller (Ten One Design), and Thumbies (Psyclone). These physical joysticks have several drawbacks. First, they are bulky and protrude substantially from the screen of the device, negating the facile portability of devices such as tablets or smartphones. Secondly, they are constrained in that they may only interact with applications which feature an on-screen joystick control of a size and shape which matches the footprint of the physical joystick. Lastly, being complex mechanical devices, the prior art physical joysticks are expensive to produce and retail for $10-30.

Accordingly, there is a need in the art for devices which aid the user in using touchscreen inputs and controllers without having to watch the position of their fingers. There is a further need in the art for solutions which are low-profile and do not affect the portability and clean aesthetics of mobile devices. Additionally, there is a need in the art for solutions which are customizable to any touchscreen-enabled application. Lastly, there is a need in the art for solutions which are inexpensive and facile to produce.

The invention disclosed herein advantageously fulfills these unmet needs, as described below.

### SUMMARY OF THE INVENTION

The invention provides tactile guides which may be reversibly adhered to the screen of a touchscreen device, allowing the user to know the position of their fingertip on the screen, with respect to displayed controls. This allows the user to quickly engage displayed controls without looking at their fingertip. The tactile guides of the invention may advantageously be configured for any software application, allowing the user to sense the position of his or her fingertip over displayed buttons, slider bars, joysticks, and other displayed controls.

### BRIEF DESCRIPTION OF THE DRAWINGS

FIG. 1. FIG. 1 depicts an exemplary tactile guide of the invention designed to be used in combination with a displayed joystick control. The tactile guide (103) is adhered to the touchscreen (102) of a touchscreen-enabled mobile device (101). The tactile guide comprises a cross-shaped piece of film having four arms (104). The arms are oriented at 90 degree angle intervals, and the end of each arm has a cutout (105) which further aids the user in identifying the up, down, left, and right orientation of the joystick control. The tactile guide further comprises a central disk-shaped button (106).

FIG. 2. FIG. 2 depicts exemplary forms of joystick guides comprising a film (201), the film having cutouts (202) and a central button (203). FIG. 2A depicts a circular tactile guide. FIG. 2B depicts a rounded diamond-shaped tactile guide. FIG. 2C depicts a cross-shaped tactile guide.

FIG. 3. FIG. 3 depicts a tactile guide of the invention (303), adhered to the touchscreen (302) of a mobile device (301) and being engaged by a user's thumb (304).

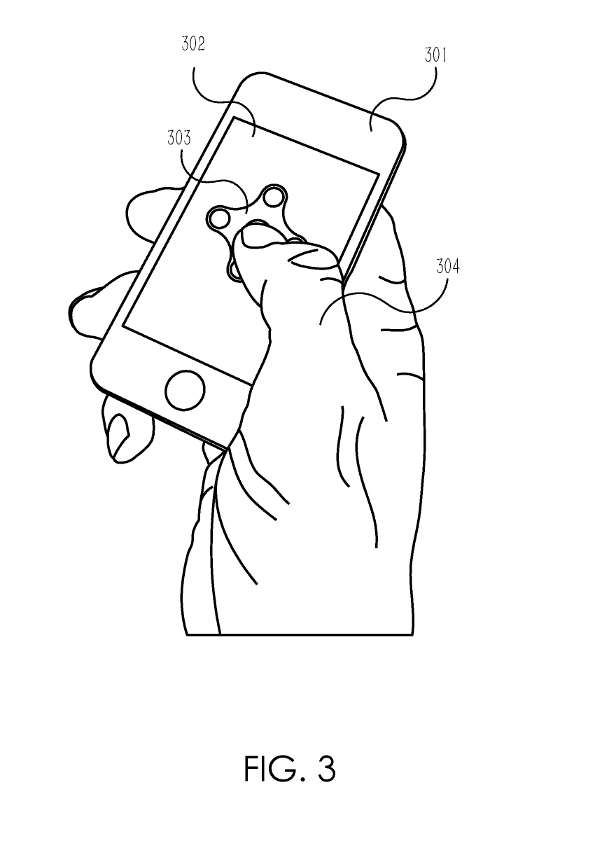

### DETAILED DESCRIPTION OF THE INVENTION

The tactile guides of the invention comprise one or more tactile elements. A tactile element is any feature that can be sensed by the fingertips and which provides positional or directional information to the user. The size of a tactile element must meet or exceed the resolution limits of human finger touch, which is reported to be about 40 microns on average. For example, tactile elements having a size in at least one dimension (e.g. width, length, or thickness, i.e. height) of 0.1 mm to 1 mm may be employed. As illustrated by the description of the many embodiments of the invention provided below, a tactile guide may comprise a single tactile element or multiple tactile elements.

In some embodiments, the tactile guide comprises a “button,” the button comprising a patch of material, for example a substantially circular disk or other shape. As used herein, with reference to tactile elements, the term “button” refers to any lump, knob, disk or other protrusion from the plane of the touchscreen. As used herein, “button” refers to a physical feature, and no mechanical or actuating control function is implied by use of the term (the buttons being capable of being either conductive or non-conductive, as discussed below). “Buttons,” as used herein, may take any shape or form. For example, a button may take the form of a soft foam or polymeric half-sphere or disk having a thickness of 0.1 to 5.0 mm. The button may have tapered or rounded edges in order to ease the user's fingertips in sliding on and off of the button. In one exemplary embodiment, the tactile guide of the invention comprises a single button. For example, such a single button could be placed in the center of a joystick control to orient the user as to the location of the joystick. In an alternative embodiment, multiple buttons are arrayed such that they delineate various displayed controls, for example, four disks or patches in circular array at 90 degree intervals can be used to delineate the up, down, left, and right directions of a displayed joystick control (such four points hereafter referred to as “compass points”). In some embodiments, the multiple buttons are separately placed on the screen by the user, allowing customized placement specific to a particular software application, or creation of a configuration preferred by the user. In other embodiments, multiple buttons are arrayed on an anchoring film comprising a conductive film coated with adhesive material or a self-adhesive film such as static cling film. The buttons are arrayed in a specific configuration, for example, delineating the compass points of a joystick control, or lining up with the placement of displayed controls specific to a particular software application. When using multiple buttons, they may be of distinguishable shapes, areal sizes, or thicknesses, which allows a user to distinguish between them by feel alone. For example a circular button may be used in combination with an oblong oval or bar-shaped button; a thin button (e.g. 0.1 mm thick) may be used in combination with a thick button (e.g. 1 mm); or a small button (e.g. having an area of 1 mm²) may be used in combination with a large button (e.g. having an area of 10 mm²). Any shape button may be used, but at least one surface of the button should be substantially flat so that it may be adhered to the flat surface of the touchscreen or to a film which is adhered to the touchscreen.

In some embodiments, the tactile guide comprises a film, i.e., a substantially flat or planar material. The film is of sufficient thickness that its contours are detectable by the fingertips, for example, having a thickness of 0.05 to 1 mm. In some embodiments, the tactile guide comprises a single button composed of film, e.g. a patch of film, for example a circular patch, or alternatively comprises a plurality of discreet patches of film.

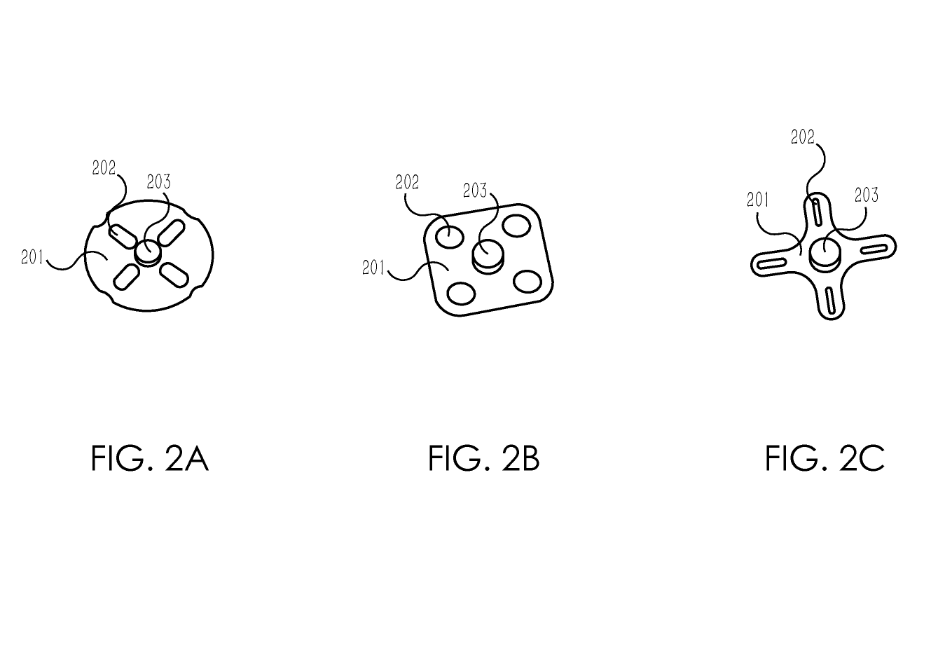

In other embodiments, a single piece of film comprises multiple tactile elements defined by the shape of the film or cutouts within the film. The contours of the film are detectable by the fingertips, such that the shape of the film provides tactile guidance to the user. For example, an oblong piece of film can orient the user as to the location and width/height of displayed “up-down” or “left-right” slider controls. A single piece of film having four radial arms (For example, as depicted in Example 1) may serve as a tactile guide delineating the compass points of a displayed joystick control. Tactile guides may further comprise “cut-outs,” which are holes or openings within the plane of the film. For example, a tactile guide comprising a film with four circular cutouts oriented at 90 degrees from each other may be utilized, as depicted in FIG. 2A. Alternatively, the film may comprise grooves or regions of variable thickness, as opposed to holes or discontinuous regions, which are detectable by the user's fingertips.

Static cling films may advantageously be utilized as tactile guides. Static cling films are materials which stick to glass and other smooth, hard surfaces by means of static electrical forces. Exemplary static cling films include polyvinyl chloride films such as Clear-Lay™ (Grafix Plastics), Colorforms™ (University Games). Additional exemplary static cling films include polyvinyidine chloride, polyester, linear low density and low density polyethylene, and other films capable of adhering touchscreen materials such as glass or polycarbonate. Static cling films have many advantages for use as tactile guides, including (1) the ability to be adhered to and easily removed from a touchscreen; (2) they are readily laser or die cut into any shape; (3) many static cling films are conductive, so that they do not interfere with the function of the touchscreen, for example when applications other than the target application are in use; (4) they are available in translucent and substantially transparent films that will not occlude the user's view of the touchscreen, and thus may be left in place when applications other than the target application are in use; and (5) they have a very low profile (for example, 0.001 to 0.012 inches in thickness), so that they will not be readily removed by the friction of placing the touchscreen device in a pocket, etc.

To enhance the tactile detection of a film, in some embodiments the tactile guide may comprise a film having a rough or tacky surface that is easily detected by the fingertips due to its higher friction. For example, the entire surface of the film or selected regions of the film could be scored, etched, coated in tacky or sticky material, or embedded with slightly abrasive or gritty materials such as particulates. Alternatively, the tactile element could be a film having thermal conductive properties and/or a specific heat capacity such that it feels distinctly cooler or warmer than the glass surface of the touchscreen.

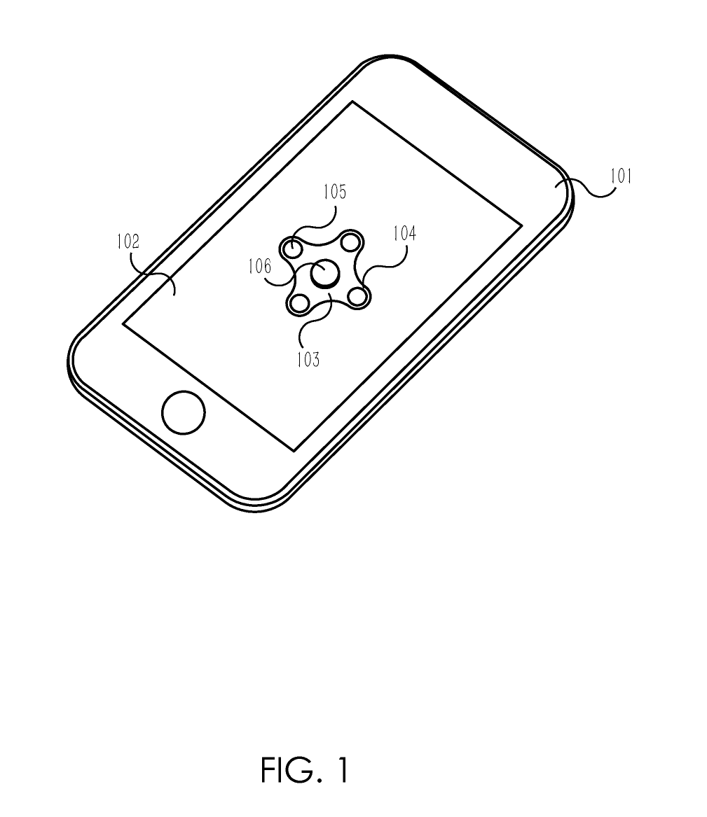

Static cling films may be utilized in combination with other materials, to create multiple tactile elements on a single piece of material that may be readily applied. For example, a static cling film having buttons made of soft foam or other materials adhered to the film may be used. For example, as depicted in FIG. 1, a tactile guide delineating the compass points of a displayed joystick control may comprise an assembly made up of a piece of static cling film (103), the shape of which comprises arms (104) that provide directional guidance, and a central button (106) adhered to the film, as well as cutouts within the film (105). In some embodiments, multiple buttons may be adhered to a single piece of static cling film in a desired configuration. In such embodiments, the static cling film acts as an anchoring platform for the buttons adhered to it (and may or may not act as a tactile guide as well).

Tactile guides require a means of being adhered to the touchscreen, or touchscreen cover, for example, protective covers made of polyurethane or polycarbonate material. One of skill in the art may readily select known adhesives or self-adhering materials that will adhere to common touchscreen materials (e.g. glass) or touchscreen protective cover materials (e.g. polyurethane, polycarbonate, or other polymeric materials known in the art and commonly used as transparent, conductive screen protective covers or films). In those embodiments where the tactile guide comprises a static cling film, the tactile guide will be self-adhering. Alternatively, if the tactile guide comprises non-self-adhesive materials, the tactile guide may be coated on one side with an adhesive which allows them to stick to the glass surface of the touchscreen. Preferred adhesives are those that can be cleanly removed from the touchscreen without leaving significant residue, for example by mechanical rubbing or with the use of solvents. Exemplary adhesives include EZ-Bond™ (Accumet Materials), T1055 (Nastar Inc.), and Easy-Tack™ (Krylon). Acrylate adhesives may also be utilized, for example as described in United States Patent Application Publication Number US20120279642 (by Wresh), the contents of which are hereby incorporated by reference in their entirety. Alternatively, tactile elements made from non-adhesive materials may be bonded (using adhesives known in the art) to a piece of self-adhering material such as static cling film. In some embodiments, the underlying layer of static cling film extends beyond the boundaries of the tactile element in order to increase the bonding surface area of the film and provide solid anchoring.

Tactile guides may be conductive or non-conductive, depending on the desired function. “Conductive” materials, as used herein, means a material of such conductivity that it will accurately transmit a user's finger or stylus touches and movements to an underlying touchscreen. In contrast, non-conductive materials will not effectively transmit the user's finger or stylus touch or movements to the underlying screen. For example, if the tactile element is meant to serve as a “parking” place for a fingertip, without activating an underlying displayed control, a non-conductive material may be employed. If the tactile element is meant to delineate the location of an underlying control, the tactile element may be made of conductive material such that it can be touched or a fingertip moved over it to activate the underlying displayed control. The tactile guides of the invention may also comprise a combination of conductive and non-conductive elements. For example, a joystick control may comprise a conductive film, the contours of which or the orientation of holes within which orient the user as to the compass points of a displayed joystick, and may further comprise a non-conductive button located in the center of the guide, which orients the user as to the location of the center of the joystick and which also acts as a parking place for the user's fingertip which will not activate any underlying displayed control.

In those embodiments in which non-conductive element or elements are used, it is generally preferred that the size of such element or elements is such that it/they not occlude a large portion of the screen, so that the tactile guides do not interfere with the operation of software applications other than the target application, and do not need to be repeatedly removed when switching between the target application and other applications.

Tactile guides may be made of any material. Exemplary materials include rubber, and polymeric materials, e.g. plastics and resins. Polymeric materials are preferred for their ease of manufacture and tunable tactile properties (for example, from hard to soft). Exemplary polymeric materials include polyoxymethylene, melamine, urea-formaldehyde, phenol-formaldehyde, polyurethane, polyethylene, polyethylene terepthalate, polyvinyl chloride, polyvinyl acetate, polypropylene, polyacrylonitrile, epoxy resin, and unsaturated polyester. Additional exemplary materials include Aflas, Buna-N, Butyl, ECH (Epichlorohydrin), EPDM (ethylene propylene diene monomer), EVA (Ethylene-vinyl acetate), Gum, Ionomer, Latex, Neoprene, Polyethylene Foam, Polyethylene Rubber, Polyimide, Polyurethane, Santoprene, SBR (styrene-butadiene rubber), Silicone, Vinyl, Viton® Fluoroelastomer, and other like materials. Further exemplary polymeric materials include soft foams made from polymeric material. Conductive or non-conductive materials may be readily selected by one of skill in the art for the desired shape, size, and manufacturing method to be employed in making the tactile guide. Conductive materials include vinyl cling films polyvinyl, polyvinyidine chloride, polyester, linear low density and low density polyethylene films. Other conductive materials include polycarbonate, polypropylene, and low density polyethylene, metalized polymeric materials, and other materials that may be configured as buttons or films. Non-conductive materials include insulators known in the art, for example, rubber or polyurethane.

Tactile guides may be readily produced using fabrication methods well known in the art. For example, if the tactile guide comprises a film, a tactile guide of the desired shape may be fabricated by laser cutting or die-punching the film. Buttons and other shapes may be produced, for example, by injection molding, compression molding, extrusion molding, blow molding, lathing, drilling, engraving, milling, and etching.

In many embodiments, it will be preferred that the tactile guide be composed of a substantially transparent or translucent material, so that it will not interfere with viewing of the underlying screen, especially when software applications other than the target application are being used. Various forms of polyvinyl cling film, for example, that are nearly transparent may be employed. Alternatively, the buttons may be colored or printed, if both visual and tactile guidance is desired. For example, vinyl static cling film is printable using various methods known in the art.

Tactile guides may be packaged in any form. For example, tactile elements adhered to a sheet of paper or cardstock to which static cling films with adhere, for example plasticized or waxy paper cardstock, UV coated cardstock, or PET or polypropylene laminated cardstock. The user may readily peel the tactile guide from the cardstock and adhere it to the touchscreen. The user may subsequently remove the tactile guide from the touchscreen and return it to the cardstock backing

### EXAMPLE

Tactile guides for a joystick control were manufactured from transparent calendared static cling film, having a thickness of 7.5 mil. Two guide shapes were fabricated, a “rounded diamond” shape (as depicted in FIG. 2A) and a circular shape (as depicted in FIG. 2B). The rounded diamond measured 19 mm on each side, and the circular guide measured about 24 mm in diameter. Each guide included four circular holes, each hole having an approximate diameter of 4.5 mm, and being located at one of the four “compass points,” i.e. the holes were offset from each other by 90 degrees. The guides were manufactured by laser cutting the shapes and circular cutouts from a larger piece of film. In the center of each guide, a dome shaped polyurethane button, having a diameter of 9.5 mm and a thickness of 3.8 mm, was adhered. The guides were provided on a UV gloss postcard backing

Each guide may be positioned on a touchscreen device above a displayed joystick control, with the circular holes aligned with the compass points of the joystick control. The film portion of the guide is conductive and will effectively transmit finger touches and movements to the screen below. The center button is non-conductive and acts as a comfortable parking spot and positional landmark for a fingertip at the center of the joystick.

The guides have been utilized for gaming applications, such as Geometry Wars™ Touch and Modern Combat 4: Zero Hour™, and enabled the user to focus his or her vision on the action of the game while effectively working the joystick control.

All patents, patent applications, and publications cited in this specification are herein incorporated by reference to the same extent as if each independent patent application, or publication was specifically and individually indicated to be incorporated by reference. The disclosed embodiments are presented for purposes of illustration and not limitation. While the invention has been described with reference to the described embodiments thereof, it will be appreciated by those of skill in the art that modifications can be made to the structure and elements of the invention without departing from the spirit and scope of the invention as a whole.

1. A tactile guide, comprising
one or more objects non-permanently adhered to the screen of a touchscreen device which are detectable by the fingertips of a user and which inform the user as to the location of displayed controls on the screen.

2. The tactile guide of claim 1, wherein
the object comprises a static cling film.

3. The tactile guide of claim 2, wherein
the static cling film comprises polyvinyl, vinyl, polyester, or low density polyethylene.

4. The tactile guide of claim 2, wherein
the static cling film comprises a two dimensional shape with four arms oriented at 90 degree intervals.

5. The tactile guide of claim 2, wherein
the static cling film comprises one or more holes or cutouts.

6. The tactile guide of claim 5, comprising
four holes or cutouts oriented at 90 degree intervals.

7. The tactile guide of claim 1, wherein
the one or more objects comprise one or more buttons, each comprising a discreet patch of material.

8. The tactile guide of claim 7, wherein
the one or more buttons comprise a discreet patch of material having a thickness of 0.1 to 5 mm and a surface area of 1 to 500 mm².

9. The tactile guide of claim 7, wherein
the one or more buttons are adhered to a piece of static cling film.

10. The tactile guide of claim 9, comprising
a single button substantially centered on the piece of static cling film.

11. The tactile guide of claim 9, wherein
the button is composed of a non-conductive material.

12. The tactile guide of claim 1, wherein
the one or more objects are sufficiently conductive that they will transmit a user's finger touches and movements to the underlying touchscreen.

13. The tactile guide of claim 1, wherein
the one or more objects inform the user as to the location of a displayed joystick control.
